(19) United States
(12) Patent Application Publication
(10) Pub. No.: US 2010/0324244 A1
(43) Pub. Date: Dec. 23, 2010

(54) 1-BUTENE COPOLYMERS

(75) Inventors: Luigi Resconi, Ferrara (IT); Davide Balboni, Ferrara (IT); Simona Esposito, Ferrara (IT)

Correspondence Address: LyondellBasell Industries, 3801 WEST CHESTER PIKE, NEWTOWN SQUARE, PA, 19073, US

(73) Assignee: Basell Poliolefine Italia s.r.l., Milano (IT)

(21) Appl. No.: 12/735,948

(22) PCT Filed: Feb. 23, 2009
(86) PCT No.: PCT/EP2009/052116

§ 371 Date: Aug. 27, 2010

Related U.S. Application Data
(60) Provisional application No. 61/072,010, filed on Mar. 27, 2008.

(30) Foreign Application Priority Data
Mar. 20, 2008 (EP) 08153125.3

(51) Int. Cl. C08F 210/08; C08F 4/52

(52) U.S. Cl. 526/226; 526/348.6

(57) ABSTRACT

A copolymer of 1-butene and at least a C₈-C₁₂ alpha-olefin derived units, preferably at least 1-octene derived units, containing from 0% to 2% by mole of propylene or pentene, having a content of C₈-C₁₂ alpha-olefin derived units higher than 0.2% and lower than 7.2% by mole; endowed with the following features: a) the melting point measured by DSC (TmII) and the C₈-C₁₂ alpha-olefin molar content fulfil the following relationship: 0<TmIK−6.5×C+104 wherein C is the molar content of C₈-C₁₂ alpha-olefin derived units and TmII is the highest melting peak in the second melting transition; b) intrinsic viscosity (IV) measured in tetrahydronaphthalene at 135° C. comprised between 0.8 and 5 dL/g; and c) isotactic pentads mmmm higher than or equal to 90%; pentads (mmrr+mrrm) lower than 4 and pentads rmmr not detectable at ¹³C NMR.

The present invention relates to copolymers of 1-butene and higher linear alpha-olefins, such as 1-octene or 1-decene, having a good distribution of the comonomer and a good balance between stiffness and crystallinity. This class of copolymers is obtained by using a specific metallocene-based catalyst system. The copolymers of the present invention are suitable for the production of films sheets and other melt-molded articles in view of their properties, or they can be used in blends with more crystalline polymers, in order to lower the stiffness and increase the softness of the latter.

Butene-1 based polymers are well known in the art and have found application in several highly demanding end uses, thanks to their high pressure resistance, creep resistance, impact strength, and flexibility. These properties can be modified by the use of comonomers.

EP 186 287 relates to random 1-butene copolymers comprising from 50% to 99% mol of 1-butene. The copolymers are described with very broad ranges of properties. In particular the melting point ranges from 30 to 120° C. depending on the type and the amount of the comonomer used. The applicant found that the polymers of the invention have lower melting point at the same comonomer content. This allows a better processability and it is the optimum for particular uses.

U.S. Pat. No. 6,288,192 relates to 1-butene homo or copolymers having a high molecular weight and no melting point. On the contrary the copolymers of the present invention show a melting point.

EP 1 260 525 relates to 1-butene copolymers having among other features a stereoregularity index (mmmm)/mmrr+rmmr at most 20. The polymers of the present invention are not endowed with this feature.

Therefore the applicant found that copolymers of 1-butene and 1-octene or higher alpha olefins having an optimum balance of features are obtainable by using a metallocene-based catalyst system.

An object of the present invention is a copolymer of 1-butene and at least a C₈-C₁₂ alpha-olefin derived units, preferably at least 1-octene derived units, containing from 0.0% to 2.0% by mole of propylene or pentene derived units, having a content of C₈-C₁₂ alpha-olefin derived units higher than 0.2% and lower than 7.2% by mole; preferably the content of C₈-C₁₂ alpha-olefin derived units is comprised between 0.5% to 7.0% by mole, endowed with the following features:

a) the melting point measured by DSC (TmII) and the C₈-C₁₂ alpha-olefin content fulfil the following relationship:

0<TmII<−6.5×C+104

wherein C is the molar content of C₈-C₁₂ alpha-olefin derived units and TmII is the highest melting peak in the second melting transition;
b) intrinsic viscosity (IV) measured in tetrahydronaphthalene at 135° C. comprised between 0.8 and 5 dL/g; preferably comprised between 0.9 and 3 dL/g; and
c) isotactic pentad mmmm higher than or equal to 90%; pentads (mmrr+mrrm) lower than 4 and pentads rmmr not detectable at ¹³C NMR.

If the content of comonomer is higher than 7.2% the copolymers become amorphous and consequently they become sticky and more difficult to process.

According to feature a) the melting point TmII and the molar content of C₈-C₁₂ alpha-olefin fulfil the relationship 0<TmII<−6.5×C+104; preferably 0<TmII<−7.0×C+104; more preferably 0<TmII<−7.5×C+104; even more preferably 0<TmII<−8×C+104; wherein C is the molar content of C₈-C₁₂ alpha-olefin derived units and TmII is the highest melting peak in the second melting transition.

The fact that the melting point fulfils the relationship 0<TmII<−6.5×C+104 allows to have a partially crystalline material having a low melting point and consequently a low crystallinity without the need to have a high content of comonomer that can worsen the other properties of the copolymer.

On the other hand, the copolymers are substantially isotactic, with mmmm≧90%, more preferably mmmm≧92%, even more preferably mmmm≧95%, thus enabling crystallization and avoiding the intrinsic stickyness of atactic or poorly isotactic polymers.

As most of 1-butene-based copolymers, the copolymers of the present invention can crystallize in at least two forms. The first form is the one kinetically stable and it is the first in which the copolymers crystallize, and give a certain melting point (TmII) then this form changes in the second form that is thermodynamically more stable. When a sample of the copolymers of the present invention are compression molded and subjected to a period of annealing by using DSC the melting point measured (TmI) can be considered the one of the thermodynamic stable form, while with the second heating run the melting point measured (TmII) is the one of the kinetically stable form.

Thus in the copolymers of the present invention the first melting transition (TmI) measured by DSC on a compression moulded plaque aged for 10 minutes in an autoclave at 2000 bar at room temperature and then aged for at least 24 hours at 23° C. fulfils the following relationship:

0<TmI<−5C+125

wherein C is the molar content of C₈-C₁₂ alpha-olefin derived units;
preferably the relationship is 0<TmI<−7C+125; more preferably 0<TmI<−9C+125.

In addition to having a moderate crystallinity, the copolymers of the present invention are endowed with a low modulus. In fact, the tensile modulus is substantially decreased with respect to that of the homopolymer, even at quite low comonomer content.

Thus the copolymers of the present invention show a tensile modulus measured by DMTA (MPa) fulfilling the following relationship:

Tens. Mod.<400×e^{-0.20C}, preferably Tens. Mod.<400×e^{-0.25C},

wherein C is the molar content of the C₈-C₁₂ alpha-olefin derived units;
In view of the excellent balance of mechanical characteristics the copolymers of the present invention can be used for several applications either alone or in blend with other polymers. In particular due to the unique balance between elastic modulus and crystallinity (measured as enthalpy of fusion) the copolymers of the present invention are endowed with a low modulus even if they maintain a relatively high crystallinity, and consequently they are devoid of stickiness and so they are more easily processable. Thus, they can be advantageously used in blends with more crystalline polymers such as poly-1-butene, in order to obtain a material which is both high melting and relatively highly crystalline and at the same time highly flexible. Because of the favourable balance between flexibility and crystallinity, the copolymers of the present invention fulfil the following relation between the enthalpy of fusion (ΔHII) and tensile modulus (TM) measured in MPa:

$$Tens . Mod \leq {0.98}^{\frac{Δ HII}{5.91}} + 273.77$$

Preferably the relation is:

$$Tens . Mod \leq {0.98}^{\frac{Δ HII}{5.91}} + 173.77$$

More preferably the relation is:

$$Tens . Mod \leq {1.68}^{\frac{Δ HII}{6.53}} + 120.84$$

Example of C₈-C₁₂ alpha-olefin comonomers are 1-octene, 1-decene, 1-dodecene. Preferably 1-octene and 1-decene are used, more preferably 1-octene is used.

The copolymers of the present invention are prepared by using metallocene-based catalyst system wherein the metallocene compound has a particular substitution pattern.

Thus the 1-butene C₈-C₁₂ alpha-olefin copolymer object of the present invention can be obtained by contacting under polymerization conditions 1-butene and at least one C₈-C₁₂ alpha-olefin and optionally propylene or pentene, in the presence of a catalyst system obtainable by contacting:
(A) a stereorigid metallocene compound;
(B) an alumoxane or a compound capable of forming an alkyl metallocene cation; and optionally
(C) an organo aluminum compound.

Preferably the stereorigid metallocene compound belongs to the following formula (I):

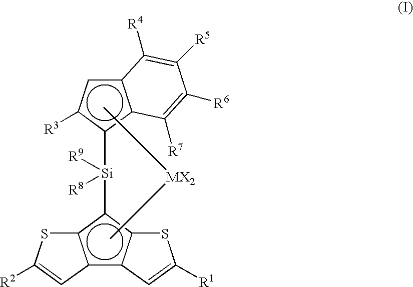

wherein:
M is an atom of a transition metal selected from those belonging to group 4; preferably M is zirconium;
X, equal to or different from each other, is a hydrogen atom, a halogen atom, a R, OR, OR′O, OSO₂CF₃, OCOR, SR, NR₂ or PR₂ group wherein R is a linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radical, optionally containing heteroatoms belonging to groups 13-17 of the Periodic Table of the Elements; and R′ is a C₁-C₂₀-alkylidene, C₆-C₂₀-arylidene, C₇-C₂₀-alkylarylidene, or C₇-C₂₀-arylalkylidene radical; preferably X is a hydrogen atom, a halogen atom, a OR′O or R group; more preferably X is chlorine or a methyl radical;
R¹, R², R⁵, R⁶, R⁷, R⁸ and R⁹, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radicals, optionally containing heteroatoms belonging to groups 13-17 of the Periodic Table of the Elements; or R⁵ and R⁶, and/or R⁸ and R⁹ can optionally form a saturated or unsaturated, 5 or 6 membered rings, said ring can bear C₁-C₂₀ alkyl radicals as substituents; with the proviso that at least one of R⁶ or R⁷ is a linear or branched, saturated or unsaturated C₁-C₂₀-alkyl radical, optionally containing heteroatoms belonging to groups 13-17 of the Periodic Table of the Elements; preferably a C₁-C₁₀-alkyl radical;
preferably R¹, R², are the same and are C₁-C₁₀ alkyl radicals optionally containing one or more silicon atoms; more preferably R¹ and R² are methyl radicals;
R⁸ and R⁹, equal to or different from each other, are preferably C₁-C₁₀ alkyl or C₆-C₂₀ aryl radicals; more preferably they are methyl radicals;
R⁵ is preferably a hydrogen atom or a methyl radical; or can be joined with R⁶ to form a saturated or unsaturated, 5 or 6 membered rings, said ring can bear C₁-C₂₀ alkyl radicals as substituents;
R⁶ is preferably a hydrogen atom or a methyl, ethyl or isopropyl radical; or it can be joined with R⁵ to form a saturated or unsaturated, 5 or 6 membered rings as described above;
R⁷ is preferably a linear or branched, saturated or unsaturated C₁-C₂₀-alkyl radical, optionally containing heteroatoms belonging to groups 13-17 of the Periodic Table of the Elements; preferably a C₁-C₁₀-alkyl radical; more preferably R⁷ is a methyl or ethyl radical; otherwise when R⁶ is different from a hydrogen atom, R⁷ is preferably a hydrogen atom
R³ and R⁴, equal to or different from each other, are linear or branched, saturated or unsaturated C₁-C₂₀-alkyl radicals, optionally containing heteroatoms belonging to groups 13-17 of the Periodic Table of the Elements; preferably R³ and R⁴ equal to or different from each other are C₁-C₁₀-alkyl radicals; more preferably R³ is a methyl, or ethyl radical; and R⁴ is a methyl, ethyl or isopropyl radical;
(A) an alumoxane or a compound capable of forming an alkyl metallocene cation; and optionally
(B) an organo aluminum compound.

Preferably the compounds of formula (I) have formula (Ia) or (Ib):

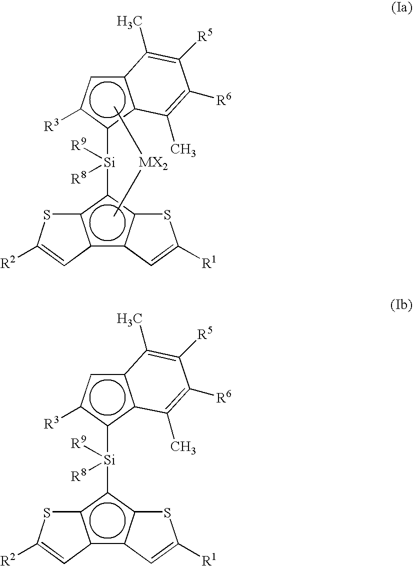

### Wherein

M, X, R¹, R², R⁵, R⁶, R⁸ and R⁹ have been described above;
R³ is a linear or branched, saturated or unsaturated C₁-C₂₀-alkyl radical, optionally containing heteroatoms belonging to groups 13-17 of the Periodic Table of the Elements; preferably R³ is a C₁-C₁₀-alkyl radical; more preferably R³ is a methyl, or ethyl radical.

Alumoxanes used as component B) can be obtained by reacting water with an organo-aluminium compound of formula HⱼAlU₃₋ⱼ or HⱼAl₂U₆₋ⱼ, where U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radical, optionally containing silicon or germanium atoms with the proviso that at least one U is different from halogen, and j ranges from 0 to 1, being also a non-integer number. In this reaction the molar ratio of Al/water is preferably comprised between 1:1 and 100:1. The molar ratio between aluminium and the metal of the metallocene generally is comprised between about 10:1 and about 20000:1, and more preferably between about 100:1 and about 5000:1. The alumoxanes used in the catalyst according to the invention are considered to be linear, branched or cyclic compounds containing at least one group of the type:

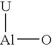

wherein the substituents U, same or different, are described above.

In particular, alumoxanes of the formula:

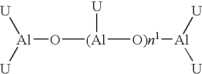

can be used in the case of linear compounds, wherein n¹ is 0 or an integer from 1 to 40 and the substituents U are defined as above, or alumoxanes of the formula:

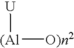

can be used in the case of cyclic compounds, wherein n² is an integer from 2 to 40 and the U substituents are defined as above. Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO). Particularly interesting cocatalysts are those described in WO 99/21899 and in WO01/21674 in which the alkyl and aryl groups have specific branched patterns. Non-limiting examples of aluminium compounds according to WO 99/21899 and WO01/21674 are:
tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBAL), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred.

Non-limiting examples of compounds able to form an alkylmetallocene cation are compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which sufficiently labile to be able to be removed by an olefinic monomer. Preferably, the anion E⁻ comprises of one or more boron atoms. More preferably, the anion E⁻ is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred examples of these compounds are described in WO 91/02012. Moreover, compounds of the formula BAr₃ can conveniently be used. Compounds of this type are described, for example, in the published International patent application WO 92/00333. Other examples of compounds able to form an alkylmetallocene cation are compounds of formula BAr₃P wherein P is a substituted or unsubstituted pyrrol radicals. These compounds are described in WO01/62764. Other examples of cocatalyst can be found in EP 775707 and DE 19917985. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Tributylammoniumtetrakispentafluorophenylaluminate,
Tributylammoniumtetrakis(3,5-bis(trifluoromethyl)phenyl)borate,
Tributylammoniumtetrakis(4-fluorophenyl)borate,
N,N-Dimethylbenzylammonium-tetrakispentafluorophenylborate,
N,N-Dimethylhexylammonium-tetrakispentafluorophenylborate,
N,N-Dimethylaniliniumtetrakis(pentafluorophenyl)borate,
N,N-Dimethylaniliniumtetrakis(pentafluorophenyl)aluminate,
Di(propyl)ammoniumtetrakis(pentafluorophenyl)borate,
Di(cyclohexyl)ammoniumtetrakis(pentafluorophenyl)borate,
Triphenylcarbeniumtetrakis(pentafluorophenyl)borate,
Triphenylcarbeniumtetrakis(pentafluorophenyl)aluminate,
Ferroceniumtetrakis(pentafluorophenyl)borate,
Ferroceniumtetrakis(pentafluorophenyl)aluminate.

Organic aluminum compounds used as compound C) are those of formula HⱼAlU₃₋ⱼ or HⱼAl₂U₆₋ⱼ described above. The catalysts of the present invention can also be supported on an inert carrier. This is achieved by depositing the metallocene compound A) or the product of the reaction thereof with the component B), or the component B) and then the metallocene compound A) on an inert support such as, for example, silica, alumina, Al—Si, Al—Mg mixed oxides, magnesium halides, styrene/divinylbenzene copolymers, polyethylene or polypropylene. The supportation process is carried out in an inert solvent such as hydrocarbon for example toluene, hexane, pentane or propane and at a temperature ranging from 0° C. to 100° C., preferably the process is carried out at a temperature ranging from 25° C. to 90° C. or the process is carried out at room temperature.

A suitable class of supports which can be used is that constituted by porous organic supports functionalized with groups having active hydrogen atoms. Particularly suitable are those in which the organic support is a partially crosslinked styrene polymer. Supports of this type are described in European application EP-633272. Another class of inert supports particularly suitable for use according to the invention is that of polyolefin porous prepolymers, particularly polyethylene.

A further suitable class of inert supports for use according to the invention is that of porous magnesium halides such as those described in International application WO 95/32995.

the process for the polymerization of 1-butene and ethylene according to the invention can be carried out in the liquid phase in the presence or absence of an inert hydrocarbon solvent. The hydrocarbon solvent can either be aromatic such as toluene, or aliphatic such as propane, hexane, heptane, isobutane or cyclohexane. Preferably the copolymers of the present invention are obtained by a solution process, i.e. a process carried out in liquid phase wherein the polymer is completely or partially soluble in the reaction medium.

As a general rule, the polymerization temperature is generally comprised between 0° C. and +200° C. preferably comprised between 40° and 90° C., more preferably between 50° C. and 80° C. The polymerization pressure is generally comprised between 0.5 and 100 bar.

The lower the polymerization temperature, the higher are the resulting molecular weights of the polymers obtained.

The following examples are for illustrative purpose and do not intend to limit the scope of the invention.

### EXAMPLES

### ¹³C NMR Analysis

¹³C-NMR spectra were acquired on a DPX-400 spectrometer operating at 100.61 MHz in the Fourier transform mode at 120° C. The peak of the 2B2 carbon (nomenclature according to C. J. Carman, R. A. Harrington, C. E. Wilkes, Macromolecules 1977, 10, 535) of the mmmm BBBBB pentad was used as internal reference at 27.73. The samples were dissolved in 1,1,2,2-tetrachloroethane-d₂ at 120° C. with a 8% wt/v concentration. Each spectrum was acquired with a 90° pulse, 15 seconds of delay between pulses and CPD (WALTZ 16) to remove ¹H—¹³C coupling. About 1500 transients were stored in 32K data points using a spectral window of 6000 Hz.

The composition of the 1-Butene/1-Octene copolymers was calculated as follows using the S_{αα} carbons:

XX=(S_{αα})_{XX}/ΣS_{αα}

BX=(S_{αα})_{BX}/ΣS_{αα}

BB=(S_{αα})_{BB}/ΣS_{αα}

Where X is the 1-octene comonomer

The total amount of 1-butene and 1-octene as molar fraction is calculated from diads using the following relations:

[X]=XX+0.5BX

[B]=BB+0.5BX

Assignment of the ¹³C NMR spectrum of 1-butene/1-octene copolymers is reported in table A, with carbon labeling as shown in formula (a)

TABLE a
(a)

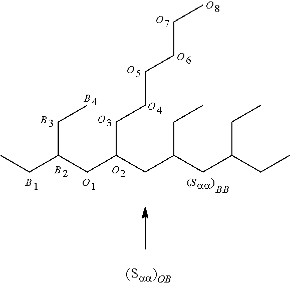

| Chemical shift | Assignment | Sequence |
|---|---|---|
| 41.43 | Sαα | OO |
| 40.82 | Sαα | OB |
| 40.22 | Sαα | BB |
| 35.66 | O3 | O |
| 35.00 | B2 | B |
| 33.69 | O2 | O |
| 32.23 | O6 | O |
| 30.19 | O5 | O |
| 27.73 | B3 | B |
| 26.88 | O4 | O |
| 22.89 | O7 | O |
| 14.19 | O8 | O |
| 10.88 | B4 | B |

### Thermal Analysis

The melting and crystallization temperatures and relative enthalpy of the polymers (TmI, TmII, ΔH_{f′}, T_{c}, ΔH_{c}) were measured by Differential Scanning Calorimetry (DSC) on a Perkin Elmer DSC-1 calorimeter equipped with Pyris 1 software, performing scans in a flowing N₂ atmosphere. DSC apparatus was previously calibrated at indium and zinc melting points. The preparation of the samples, for calorimetric investigations, was performed by cutting them into small pieces by using a cutter. The weight of the samples in every DSC crucible was kept at 6.0±0.5 mg.

In order to obtain the melting and the crystallization temperatures of the copolymers, the weighted sample was sealed into aluminium pans and heated to 180° C. at 10° C./minute. The sample was kept at 180° C. for 5 minutes to allow a complete melting of all the crystallites, and then cooled down to −20° C. at 10° C./minute. After standing 2 minutes at −20° C., the sample was heated for the second time to 180° C. at 10° C./min. In the cooling DSC run the T_{c} and the ΔH_{c} have been detected, while the second melting temperature (TmII) and the relative enthalpy of fusion were detected in the second heating DSC run.

Melting temperature (TmI) and the relative enthalpy of fusion in the first heating DSC run were detected on compression-molded samples aged 10 minutes in the autoclave at high pressure (2000 bar) at room temperature and then aged at least 24 hours at 23° C.

The glass transition temperature (T_{g}) was also detected from DSC analysis in the second heating run from −90° C. up to 180° C. at 10° C./min. The weight of the samples in every DSC crucible was kept at 12.0±1.0 mg. The value of the inflection point of the transition was taken as the T_{g}.

Stress-Strain

Mechanical tests were performed with a mechanical tester apparatus (INSTRON 4301), following the international standard ISO 527/1.

Compression-molded samples were prepared by heating the samples at temperatures higher than the melting temperatures (200° C.) under a press for 5 minutes and then cooling the melt to room temperature with a cooling rate of 30° C./min. Before performing the tensile measurements, these compression molded butene copolymers were aged for 10 minutes in an autoclave (water) at high pressure (2000 bar) at room temperature and then aged for additional 24 hours at 23° C. Rectangular specimens 30 mm long, 5 mm wide, and 2 mm thick were uniaxially drawn up to the break at room temperature at 500 mm/min and stress-strain curves were collected. For each samples 6 stress-strain curves were collected and averaged. In this way stress at yield, elongation at yield, stress at break and elongation at break have been measured.

Tension Set Calculation

Compression-molded samples were prepared by heating the samples at temperatures higher than the melting temperatures (200° C.) under a press for 5 minutes and then cooling the melt to room temperature with a cooling rate of 30° C./min. Before performing the tensile measurements, these compression molded butene copolymers were aged for 10 minutes in an autoclave (water) at high pressure (2000 bar) at room temperature and then aged for additional 24 hours at 23° C. The values of the tension set were measured according to the method ISO 2285. Rectangular specimens 50 mm long, 2 mm wide, and 2 mm thick were uniaxially drawn from their initial length L₀ up to a length L_{f}=2L₀ i.e., up to the elongation ε=[(L_{f}−L₀)/L₀]*100=100% (deformation rate not constant but high), and held at this elongation for 10 minutes, then the tension was removed and the final length of the relaxed specimens Lᵣ was measured after 10 minutes. The tension set was calculated by using the following formula: tₛ(ε)=[(Lᵣ−L₀)/L₀]*100.

The value of the tension set is the average of two measures.

DMTA

Tensile modulus (at 23° C.) has been measured by using DMTA. Seiko DMS6100 equipped with liq. N₂ cooling accessory instrument with heating rate of 2° C./min and frequency of 1 Hz. The specimens were cut from compression molded plaque with dimensions of 50×6×1 mm. The investigated temperature range was from −80° C. to the softening point.

Catalyst Preparation

Dimethylsilanediyl {(1-(2,4,7-trimethylindenyl)-7-(2,5-dimethyl-cyclopenta[1,2-b:4,3-b′]-dithiophene)}Zirconium dichloride (Al) was prepared according to WO 01/47939. Methylalumoxane (MAO) was supplied by Albemarle as a 30% wt/wt toluene solution and used as such. Triisobutylaluminium (TIBA) was supplied by Crompton as pure chemical and diluted to about 100 g/L with anhydrous cyclohexane. All chemicals were handled using standard Schlenk techniques.

Preparation of the Catalytic solution (Alₜₒₜ/Zr=400 molar, Al_{MAO}/Zr=267 mol/mol in cyclohexane/toluene)

22 mg of Al were charged at room temperature under nitrogen atmosphere into a 50 mL Schlenk flask, equipped with a magnetic stirrer. 16.2 mL of a mixture of MAO Albemarle 30% wt in toluene and TIBA in cyclohexane (25.3 g Alₜₒₜ/L; MAO/TIBA=2/1 molar) were added at room temperature under nitrogen atmosphere into the schlenk containing the Al (Al_{MAO}/Zr=267; Al_{TIBA}/Zr=133, Alₜₒₜ/Zr=400). The resulting clear orange-red solution, having a concentration of Al of 1.36 mg/mL, was stirred for 1-2 hours at room temperature and used as such in polymerizations.

### Polymerization Tests

The polymerization tests were carried out in a 4.4 L jacketed stainless-steel autoclave equipped with a mechanical stirrer and a 35-mL stainless-steel vial, connected to a thermostat for temperature control, by using the following procedure. Prior to the polymerization experiment, the autoclave was purified by washing with a 1M Al(i-Bu)₃ solution in hexane and dried at 70° C. in a stream of nitrogen. Subsequently, the scavenger (either an amount of a 25.3 g(Alₜₒₜ)/L solution in toluene/cyclohexane of MAO/TIBA=2/1 molar corresponding to 4 mmol of Al, or 11.9 mL of a solution of TIBA 10% wt/V in iso-hexane, corresponding to 6 mmol of TIBA) and then the desired amounts (see Table 1) of butene and octene (or decene) were charged at room temperature in the autoclave. The autoclave was then thermostated at the polymerization temperature of 70° C. The solution containing the catalyst/cocatalyst mixture was injected in the autoclave by means of nitrogen pressure through the stainless-steel vial. The polymerization was carried out at constant temperature for 1 h, without feeding monomers.

Then stirring was interrupted, the pressure into the autoclave was raised up to 20 bar-g with nitrogen, the bottom discharge valve was opened and the polymer/monomers mixture discharged into a heated steel tank containing water and treated for 10 min with a steam flow. The tank heating was switched off and a flow of nitrogen at 0.5 bar-g was fed to remove the water. The steel tank was finally opened, the wet polymer collected and dried overnight at 85° C. in an oven under reduced pressure.

The polymerization results are reported in table 1.

TABLE 1

| | mg of | Scavenger | Butene | Octene | Yield |
|---|---|---|---|---|---|
| Ex | metallocene | (mmol as Al) | (g) | (g) | (g) |
| 1* | 1.9 | MAO/TIBA (4) | 1350 | 0 | 284 |
| 2 | 2.5 | TIBA (6) | 1350 | 13.9 | 123 |
| 3 | 3.5 | TIBA (6) | 1350 | 39.3 | 269 |
| 4 | 2.4 | MAO/TIBA (4) | 1295 | 82.1 | 295 |
| 5 | 1.7 | MAO/TIBA (4) | 1300 | 110 | 259 |
| 6 | 2.2 | MAO/TIBA (4) | 1243 | 148 | 203 |
| 7 | 1.9 | MAO/TIBA (4) | 1300 | 193 | 118 |

| | Octene in the | | | | | I.V. |
|---|---|---|---|---|---|---|
| | polymer | | | | activity | dL/g |
| Ex | % mol (¹³C NMR) | mmrr + mrrm % | mmmm % | rmmr | kg/g_{MC}/h | (THN) |
| 1* | 0 | <4 | >96 | nd | 150 | 1.7 |
| 2 | 0.3 | <4 | >96 | nd | 49 | 2.2 |
| 3 | 1.0 | <4 | >96 | nd | 77 | 1.9 |
| 4 | 2.8 | <4 | >96 | nd | 123 | 1.4 |
| 5 | 4.0 | <4 | >96 | nd | 152 | 1.4 |
| 6 | 5.6 | <4 | >96 | nd | 93 | 1.9 |
| 7 | 6.7 | <4 | >96 | nd | 62 | 1.4 |

nd = not detectable
*comparative

The copolymers obtained in the above examples have been analyzed:

### Thermal Analysis

Thermal analysis have been carried out according to the procedure described above, the results are reported in table 2

TABLE 2

| | C8 % | | | | | | | |
|---|---|---|---|---|---|---|---|---|
| | mol | TₘII | ΔH_{f}II | T_{c} | ΔH_{C} | TₘI | ΔH_{f}(I + II) | |
| Ex | (NMR) | (° C.) | (J/g) | (° C.) | (J/g) | (° C.) | (J/g) | T_{g} ° C. |
| 1* | — | 103.3 | 33.3 | 60.2 | 30 | 119.8 | 69 | −28.8 |
| 2 | 0.30 | 99.1 | 32 | 65.9 | 28 | 116.3 | 65 | −30.2 |
| 3 | 0.97 | 89.8 | 28 | 52.0 | Nm | 104.6 | 54 | −31.1 |
| 4 | 2.81 | 73.5 | 21 | 27.7 | 12 | 87.5 | 47 | Nm |
| 5 | 3.95 | 64.0 | 16 | Nd | 0 | 69.2 | 29 | −35.6 |
| 6 | 5.58 | 56.0 | 0.4 | Nd | 0 | 57.1 | 21 | Nm |
| 7 | 6.73 | 45.6 | 0.4 | Nd | 0 | 46.2 | 25 | −36.5 |

*comparative
Nd = not detectable
Nm = not measured

### Mechanical Analysis

Stress-strain, tension set and tensile moduli measurements have been carried out according to the procedure described above. The results of the mechanical analysis are shown in table 3.

TABLE 3

| | Tensile | | | Tension set |
|---|---|---|---|---|
| | Modulus 23° C. | stress@break | elongation@ | 100% |
| Ex | DMTA (MPa) | (MPa) | break (MPa) | deform. (%). |
| 1* | 360 | 36.0 ± 2.3 | 314 ± 15 | 67 |
| 2 | 280 | 35.1 ± 1.6 | 313 ± 16 | 63 |
| 3 | 170 | 36.7 ± 1.4 | 367 ± 11 | 71 |
| 4 | 130 | 27.9 ± 4 | 390 ± 30 | 70 |
| 5 | 105 | 28.2 ± 1.6 | 510 ± 45 | 63 |
| 6 | 68.5 | Nm | Nm | 69 |
| 7 | 58.6 | 14.4 ± 1.9 | 550 ± 27 | 45 |

*comparative
Nm = not measured

1. A copolymer of 1-butene and at least a C₈-C₁₂ alpha-olefin derived units, containing from 0% to 2% by mole of propylene or pentene derived units, having a content of C₈-C₁₂ alpha-olefin derived units higher than 0.2% and lower than 7.2% by mole; endowed with the following features:
a) the melting point measured by DSC (TmII) and the C₈-C₁₂ alpha-olefin molar content fulfil the following relationship:
0<TmII<−6.5×C+104
wherein C is the molar content of C₈-C₁₂ alpha-olefin derived units and TmII is the highest melting peak in the second melting transition;
b) intrinsic viscosity (IV) measured in tetrahydronaphthalene at 135° C. is between 0.8 and 5 dL/g; and
c) isotactic pentads mmmm higher than or equal to 90%; pentads (mmrr+mrrm) lower than 4 and pentads rmmr not detectable at ¹³C NMR.

2. The copolymer according to claim 2 wherein the C₈-C₁₂ alpha-olefin is 1-octene.

3. The copolymer according to claim 2 wherein the relationship between the melting point (TmII) and the molar content of the alpha olefin (C) is
0<TmII<−6.5×C+104

4. The copolymer according to claim 3 wherein when said copolymer is subjected to a period of annealing of 10 days fulfils the following relationship:
0<TmI<−5×C+125
Wherein TmI is the first melting transition measured by DSC on a compression moulded plaque aged for 10 minutes in an autoclave at 2000 bar at room temperature and then aged for at least 24 hours at 23° C. and C is the molar content of the C₈-C₁₂ alpha-olefin derived units.

5. The copolymer according to claim 4 wherein the tensile modulus measured by DMTA (MPa) and the molar content of the C₈-C₁₂ alpha-olefin fulfil the following relationship:
Tens. Mod.<400×e^{-0.20C}

6. The copolymer according to claim 5 wherein the relationship is
Tens. Mod.<400×e^{-0.25C}

7. The copolymer according to claim 6 wherein the tensile modulus measured by DMTA (MPa) and the enthalpy of fusion (ΔHII) measured by DSC fulfil the following relationship:
Tens. Mod≦0.98^{ΔHII/5.91}+273.77

8. The copolymer according to claim 7 wherein the relationship is
Tens. Mod≦0.98^{ΔHII/5.91}+173.77

9. The copolymer according to claim 8 wherein the content of C₈-C₁₂ alpha-olefin derived units is comprised between 0.5% to 7% by mol.

10. A process for the production of the copolymers of claim 1 comprising contacting under polymerization conditions 1-butene and the C₈-C₁₂ alpha-olefin in the presence of a catalyst system obtainable by contacting:
a) a stereorigid metallocene compound;
b) an alumoxane or a compound capable of forming an alkyl metallocene cation; and optionally
c) an organo aluminum compound.
